(19) United States
(12) Patent Application Publication
(10) Pub. No.: US 2014/0129991 A1
(43) Pub. Date: May 8, 2014

(54) CHARACTER INPUT PROMPTING METHOD AND ELECTRONIC DEVICE

(71) Applicant: Huawei Device Co., Ltd., Shenzhen (CN)

(72) Inventors: Konggang WEI, Shenzhen (CN); Guanghua ZHONG, Shenzhen (CN)

(73) Assignee: Huawei Device Co., Ltd., Shenzhen (CN)

(21) Appl. No.: 14/096,719

(22) Filed: Dec. 4, 2013

Related U.S. Application Data
(63) Continuation of application No. PCT/CN2013/070090, filed on Jan. 6, 2013.

(30) Foreign Application Priority Data
Jun. 4, 2012 (CN) 201210181317.0

(51) Int. Cl. G06F 3/0481

(52) U.S. Cl. CPC G06F 3/04812
USPC 715/856

(57) ABSTRACT

Embodiments of the present invention provide a character input prompting method and relate to the field of computers, so that a modification or insertion process can be simpler. The method includes: obtaining a position of a cursor; obtaining a first character before the position of the cursor and adjacent to the cursor and a second character after the position of the cursor and adjacent to the cursor, where the first character is a single character or a character string including multiple characters, and the second character is a single character or a character string including multiple characters; obtaining, from an input method database, a character grammatically associated with at least one of: the first character and the second character; and prompting, in the form of a candidate character list, a user for the character grammatically associated with at least one of: the first character and the second character.

### CROSS-REFERENCE TO RELATED APPLICATIONS

This application is a continuation of International Patent Application No. PCT/CN2013/070090, filed on Jan. 6, 2013, which claims priority to Chinese Patent Application No. 201210181317.0, filed on Jun. 4, 2012, both of which are hereby incorporated by reference in their entireties.

### TECHNICAL FIELD

The present invention relates to the field of computers, and in particular, to a character input prompting method and electronic device.

### BACKGROUND

At present, most input methods support word input, and also support sentence input. However, when editing a document, a user often needs to make a modification at a certain position in the middle of a sentence. In current input methods, the user has to move a cursor to a modification position and then in the same way as sequential input, inputs a code through a method such as Pinyin or Wubi; and only in this way, a character that needs to be added or modified can be inserted into the sentence. Such a process may require the user to use a mouse and a keyboard in combination to achieve a purpose of modification. The process is complex, thereby reducing a text editing processing speed of an electronic device.

### SUMMARY

Embodiments of the present invention provide a character input prompting method and electronic device, so that a modification or insertion process can be simpler, thereby improving a text editing processing speed of an electronic device.

Embodiments of the present invention adopt the following technical solutions:

In one aspect, an embodiment of the present invention provides a character input prompting method, where the method includes:
obtaining a position of a cursor;
obtaining a first character before the position of the cursor and adjacent to the cursor and a second character after the position of the cursor and adjacent to the cursor, where the first character is a single character or a character string including multiple characters, and the second character is a single character or a character string including multiple characters;
obtaining, from an input method database, a character grammatically associated with at least one of: the first character and the second character; and
prompting, in the form of a candidate character list, a user for the character grammatically associated with at least one of: the first character and the second character.

In another aspect, an embodiment of the present invention provides an electronic device, where the electronic device includes:
a detecting unit, configured to obtain a position of a cursor;
an obtaining unit, configured to obtain a first character before the position of the cursor and adjacent to the cursor and a second character after the position of the cursor and adjacent to the cursor, where the first character is a single character or a character string including multiple characters, and the second character is a single character or a character string including multiple characters;
a matching unit, configured to obtain, from an input method database, a character grammatically associated with at least one of: the first character and the second character; and
a prompting unit, configured to prompt, in the form of a candidate character list, a user for the character grammatically associated with at least one of: the first character and the second character.

The embodiments of the present invention provide a character input prompting method and electronic device. A position of a cursor can be detected, and characters before and after the cursor are obtained; and then an input method database is searched for a character grammatically associated with the characters before and after the cursor and a user is prompted, in the form of a list, for the character grammatically associated with the characters before and after the cursor, so that the user can perform selection, and a modification or insertion process is simpler, thereby improving a text editing processing speed of an electronic device.

### BRIEF DESCRIPTION OF DRAWINGS

To describe the technical solutions in the embodiments of the present invention more clearly, the accompanying drawings required for describing the embodiments or are introduced briefly in the following. Apparently, the accompanying drawings in the following description show only some embodiments of the present invention, and persons of ordinary skill in the art may also obtain other drawings according to these accompanying drawings without creative efforts.

FIG. 1 is a schematic flow chart of a character input prompting method according to Embodiment 1 of the present invention;

FIG. 2 is a schematic flow chart of a character input prompting method according to Embodiment 2 of the present invention;

FIG. 3 is a schematic diagram of the character input prompting method according to Embodiment 2 of the present invention;

FIG. 4 is a second schematic diagram of the character input prompting method according to Embodiment 2 of the present invention;

FIG. 5 is a third schematic diagram of the character input prompting method according to Embodiment 2 of the present invention;

FIG. 6 is a schematic structural diagram of an electronic device according to Embodiment 3 of the present invention;

FIG. 7 is a schematic structural diagram of another electronic device according to Embodiment 3 of the present invention; and

FIG. 8 is a schematic structural diagram of still another electronic device according to Embodiment 3 of the present invention.

### DETAILED DESCRIPTION OF EMBODIMENTS

The technical solutions in the embodiments of the present invention are clearly described in the following with reference to the accompanying drawings in the embodiments of the present invention. Apparently, the embodiments to be described are only a part rather than all of the embodiments of the present invention. All other embodiments obtained by persons of ordinary skill in the art based on the embodiments of the present invention without creative efforts shall fall within the protection scope of the present invention.

The terms used in the embodiments of the present invention are only used to describe specific embodiments, but are not intended to limit the present invention. Unless otherwise specified clearly in the context, the words “one”, “the”, and “said” in a singular form used in the embodiments of the present invention and the appended claims also imply a plural form semantically. It should also be noted that, the term “and/or” used in this application refers to and includes any one or all possible combinations of the listed one or more associated items.

### Embodiment 1

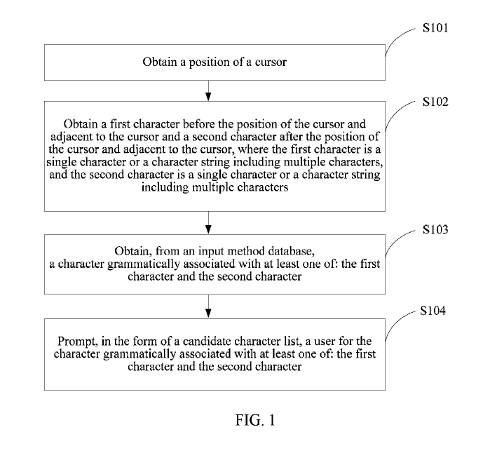

Embodiment 1 of the present invention provides a character input prompting method. As shown in FIG. 1, the method specifically includes:

S101: Obtain a position of a cursor.

S102: Obtain a first character before the position of the cursor and adjacent to the cursor and a second character after the position of the cursor and adjacent to the cursor, where the first character is a single character or a character string including multiple characters, and the second character is a single character or a character string including multiple characters.

S103: Obtain, from an input method database, a character grammatically associated with at least one of: the first character and the second character.

S104: Prompt, in the form of a candidate character list, a user for the character grammatically associated with at least one of: the first character and the second character.

The embodiment of the present invention provides a character input prompting method. A position of a cursor can be detected, and characters before and after the cursor are obtained; and then an input method database is searched for a character grammatically associated with the characters before and after the cursor and a user is prompted, in the form of a list, for the character grammatically associated with the characters before and after the cursor, so that the user can perform selection, and a modification or insertion process is simpler, thereby improving a text editing processing speed of an electronic device.

### Embodiment 2

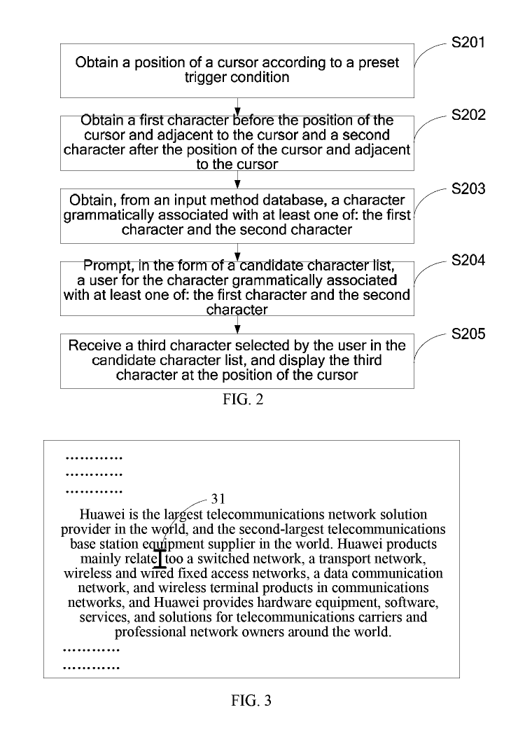

Embodiment 2 of the present invention provides a character input prompting method. As shown in FIG. 2, the method includes:

S201: Obtain a position of a cursor according to a preset trigger condition.

Exemplarily, first of all, when an electronic device detects that a cursor stops moving, the electronic device detects retention duration of the cursor; and when it is detected that the retention duration of the cursor reaches preset duration, the electronic device determines that the current position of the cursor requires modification or insertion, and obtains the current position of the cursor.

Alternatively, according to a cursor position obtaining instruction received from a user, the position of the cursor may be obtained by executing the cursor position obtaining instruction. In this case, the user may use a shortcut key on a keyboard to generate the cursor position obtaining instruction, and may also long press a left mouse button or a right mouse button to generate the cursor position obtaining instruction. The electronic device obtains the current position of the cursor after receiving the cursor position obtaining instruction.

Definitely, two trigger manners may also be combined. After the cursor stops moving, the electronic device starts detecting retention duration of the cursor. If the retention duration of the cursor does not reach the preset duration, the current position of the cursor is immediately obtained upon receiving a cursor position obtaining instruction from the user; and if no cursor position obtaining instruction is received from the user, the current position of the cursor is obtained when the retention duration of the cursor reaches the preset duration.

Further, in addition to the foregoing trigger manners, a microphone may also be used to trigger, through sound, the obtaining of the position of the cursor; or a camera of the electronic device may be used to trigger, through a special gesture, the obtaining of the position of the cursor.

Exemplarily, a coordinate of the current position of the cursor may be obtained by using a GetCaretPos function, and a coordinate of the current position of the cursor may also be obtained by using a GetGUIThreadInfo function. In consideration of the universality of a system and software, the latter is recommended.

S202: Obtain a first character before the position of the cursor and adjacent to the cursor and a second character after the position of the cursor and adjacent to the cursor.

Exemplarily, after the position of the cursor is obtained through detection, the first character is obtained by performing character obtaining backwards from the position of the cursor to a text control character; and the second character is obtained by performing character obtaining forwards from the position of the cursor to a text control character.

The text control character includes: a punctuation mark, a carriage return, and a line break. For example, if the cursor is located in the middle of a paragraph, the first character is obtained by performing character obtaining backwards from the position of the cursor to a punctuation mark; and the second character is obtained by performing character obtaining forwards from the position of the cursor to a punctuation mark. If the cursor is located at the beginning of a paragraph, character obtaining is performed backwards from the position of the cursor to a carriage return, and in this case, the first character is null. If a sentence where the cursor is located is not finished and no punctuation mark follows the position of the cursor, the second character is obtained by performing character obtaining forwards from the position of the cursor to a carriage return.

For example, in an operating system of the electronic device, an API (Application Programming Interface, application programming interface) function and a TextOut (output) function need to be invoked for output and display of all text. Therefore, characters before and after the position of the cursor may be obtained by adopting a manner of establishing a hook (Hook) with the API function.

First, an address of the TextOut function is found by searching a memory space of the system; and then, parameters of the TextOut function are transferred to a target function, and the cursor of the electronic device jumps to the target function. The target function is used for word selection of the cursor, and the parameters of the TextOut function include: HDC hdc, int nXStart, int nYStart, LPCTSTR lpString, and int cbString.

The system may run multiple windows for editing text at the same time, and therefore, after the cursor of the electronic device jumps to the target function, the target function first determines whether a window that requires character obtaining is a current window; if yes, character obtaining is performed; and otherwise, no processing is performed.

Exemplarily, after the cursor of the electronic device jumps to the target function, the electronic device determines, by using the target function, whether the HDC hdc is a window handle of the current position of the cursor. The electronic device may open multiple windows at the same time, and therefore, it is determined whether the HDC hdc is a window handle of the current position of the cursor, so as to identify whether the cursor is located in a current operating window. If the HDC hdc is not a window handle of the current position of the cursor, no processing is performed; and if the HDC hdc is a window handle of the current position of the cursor, the target function copies the parameters of the TextOut function, where the int nXStart and int nYStart represent coordinates of an output character of the TextOut function, and the LPCTSTR lpString represents content of the output character. After the copy is completed, the cursor returns from the target function to the TextOut function, and the TextOut function is continued to be executed, so that an output character of the current window can be displayed normally.

Afterward, according to the coordinates of the output character, namely, the int nXStart and int nYStart, and the content of the output character, namely, the LPCTSTR lpString, and in combination with the current position of the cursor, character obtaining is performed backwards from the position of the cursor to a punctuation mark and character obtaining is also performed forwards from the position of the cursor to a punctuation mark by using the target function. In this way, the first character before the position of the cursor and the second character after the position of the cursor are both obtained.

Further, to avoid that an obtained character is too long, a preset character length may be set in the electronic device to serve as an upper limit for the length of the obtained character.

In this way, character obtaining is performed backwards from the position of the cursor, and if no text control character is obtained but the length of an obtained character reaches the preset character length, the obtaining is stopped to obtain the first character.

In the same way, character obtaining is performed forwards from the position of the cursor, and if no text control character is obtained but the length of an obtained character reaches the preset character length, the obtaining is stopped to obtain the second character.

The first character may be a single character or a character string including multiple characters; and the second character may be a single character or a character string including multiple characters. In other words, the first character may be a character, may also be a word, and may also be a sentence; and in the same way, the second character may be a character, may also be a word, and may also be a sentence.

S203: Obtain, from an input method database, a character grammatically associated with at least one of: the first character and the second character.

First, starting from a character, which is closest to the position of the cursor, of the obtained first character, characters are added backwards one by one, and fuzzy matching is performed between the characters that are added backwards one by one and characters in the input method database, where the input method database includes a character library, a word library, and a sentence library, until matching for all of the first character is finished, so as to find a character that can form a word with the first character or a character that can form a sentence with the first character, where the character may be a single character or a character string including multiple characters, that is, the character may be a character, a word, or a sentence.

Exemplarily, in the first character, fuzzy matching is performed between a character in first place before the position of the cursor and a character, a word, and a sentence in the input method database, so as to find a character that can form a word with the character in first place or a character that can form a sentence with the character in first place. After matching for the character in first place is finished, a character is added backwards and fuzzy matching is performed between the character and a character, a word, and a sentence in the input method database, that is, fuzzy matching is performed between a character string formed by the character in first place and a character in second place before the position of the cursor and a character, a word, and a sentence in the input method database, so as to find a character that can form a word with the character string or a character that can form a sentence with the character string. The rest is done in the same manner until matching for all of the first character is finished.

In the second character, starting from a character, which is closest to the position of the cursor, of the second character, characters are added forwards one by one, and fuzzy matching is performed between the characters that are added forwards one by one and characters in the input method database, where the input method database includes a character library, a word library, and a sentence library, until matching for all of the second character is finished, so as to find a character that can form a word with the second character or a character that can form a sentence with the second character, where the character may be a single character or a character string including multiple characters, that is, the character may be a character, a word, or a sentence. A specific process is exactly the same as that of the first character, and is not described in detail herein again.

It should be noted that during the fuzzy matching, matching may be performed with the first character, may also be performed with the second character, and may also be performed with the first character and the second character at the same time. Definitely, when the matching is performed with the first character and the second character at the same time, an obtained grammatically associated character is a character that has grammatical association with both the first character and the second character, namely, a character that can form a word or a sentence with both the first character and the second character, where the character may be a single character, and may also be a character string including multiple characters. A specific matching manner may be set according to an actual requirement, which is not limited in this embodiment.

S204: Prompt, in the form of a candidate character list, a user for the character grammatically associated with at least one of: the first character and the second character.

The user is prompted for the found character that can form a word or a sentence with the first character, the found character that can form a word or a sentence with the second character, or the found character that can form a word or a sentence with the first character and the second character, and the found character may be displayed, for example, in the form of a list.

In another embodiment of the present invention, characters may be displayed in a candidate character list in descending order of a matching degree. The matching degree may be set according to the grammar; a character, word, or sentence that can form a grammatically optimal combination with the first character or the second character is displayed on the top of the list for the user to select.

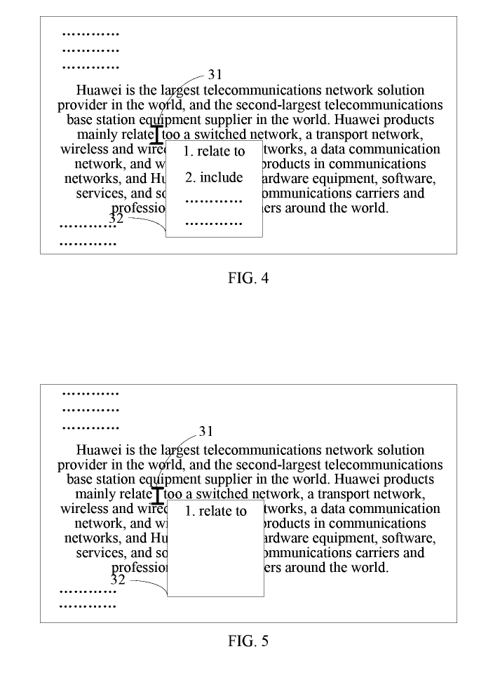

Exemplarily, in a paragraph shown in FIG. 3, the numeral 31 represents a cursor, and the cursor is located at the word “ [symbol] ”. When an electronic device detects that retention duration of the cursor 31 at this position reaches preset duration, or receives a cursor position obtaining instruction, the electronic device obtains a current position of the cursor 31. Then, a first character is obtained by obtaining characters backwards from the position of the cursor to a punctuation mark; and a second character is obtained by obtaining characters forwards from the position of the cursor to a punctuation mark. It can be known from FIG. 3 that, the first character is “ [symbol] ”, and the second character is “ [symbol] [symbol] [symbol] ”. Afterwards, the electronic device performs fuzzy matching between the first character and an input method database. To be more accurate, optionally, the electronic device may also perform fuzzy matching between the second character and the input method database. Characters obtained after the matching are displayed in a candidate character list in descending order of a matching degree, so that the user can perform selection to replace an error at the position of the cursor. For example, as shown in FIG. 4, “ [symbol] ” may be displayed on the top of the list 32, and the next may be “ [symbol] ”.

S205: Receive a third character selected by the user in the candidate character list, and display the third character at the position of the cursor, where the third character may be a single character or a character string including multiple characters, that is, the third character may be a character, may be a word, and may also be a sentence.

As shown in FIG. 4, in the character list 32, an optimal option is a first option, namely, “ [symbol] ”. When the third character that is received by the electronic device and selected by the user is the first option, the electronic device displays “ [symbol] ” at the position of the cursor 31, that is, between “ [symbol] ” and “ [symbol] ”, and then the user may manually delete the two characters “ [symbol] ” and “ [symbol] ”.

Alternatively, further, when the candidate character list has only one candidate third character, the electronic device automatically displays the third character at the position of the cursor, where the third character herein may be a single character or a character string including multiple characters, that is, the third character may be a character, may be a word, and may also be a sentence; and moreover, the third character herein may be the same as and may also be different from the foregoing third character selected by the user in the candidate character list.

As shown in FIG. 5, the candidate character list 32 has only one option: “ [symbol] ”. In this case, the electronic device may automatically display “ [symbol] ” at the position of the cursor 31, that is, between “ [symbol] ” and “ [symbol] ”, and in this way, automatic insertion is completed. Then, the user may manually delete the two characters “ [symbol] ” and “ [symbol] ”, that is, manual replacement is completed.

When the candidate character list has multiple options, the third character that serves as the first option is displayed at the position of the cursor. The third character herein may be a single character or a character string including multiple characters, that is, the third character may be a character, may be a word, and may also be a sentence; and moreover, the third character herein may be the same as and may also be different from the foregoing third character selected by the user in the candidate character list and the third character that is the only one candidate.

As shown in FIG. 4, the candidate character list 32 includes multiple options, for example, the first option is “ [symbol] ”, and a second option is “ [symbol] ”, where the first option “ [symbol] [symbol] ” is an optimal option. In this case, the electronic device may automatically display the first option “ [symbol] ” at the position of the cursor 31, that is, between “ [symbol] ” and “ [symbol] ”, and in this way, automatic insertion is completed. Afterward, the user may manually delete the two characters “ [symbol] ” and “ [symbol] ”, that is, manual replacement is completed.

Further, before displaying “ [symbol] ”, the electronic device may first determine whether a fourth character formed by characters before and after the position of the cursor has the same attribute as that of the third character. In a general case, the fourth character may have the same length as that of the third character, and the same attribute may refer to the same pronunciation or the same meaning.

When the fourth character has the same attribute as that of the third character, the fourth character is deleted, so that the fourth character is deleted and replaced with the third character. The fourth character may be deleted by invoking a Delete function.

For example, in a paragraph shown in FIG. 4, the Delete function is invoked to delete “ [symbol] ” at the position of the cursor 31, and then, after the deletion, “ [symbol] ” is displayed at the position of the cursor 31, and in this way, automatic replacement of an error word in a document is completed.

Definitely, except that there is no character deletion step, other steps of a method for inserting a character at a position where a character is missing are the same as those of the foregoing method, and are not described herein again.

The embodiment of the present invention provides a character input prompting method. A position of a cursor can be detected, and characters before and after the cursor are obtained; and then an input method database is searched for a character grammatically associated with the characters before and after the cursor and a user is prompted, in the form of a list, for the character grammatically associated with the characters before and after the cursor, so that the user can perform selection, and a modification or insertion process is simpler, thereby improving a text editing processing speed of an electronic device.

### Embodiment 3

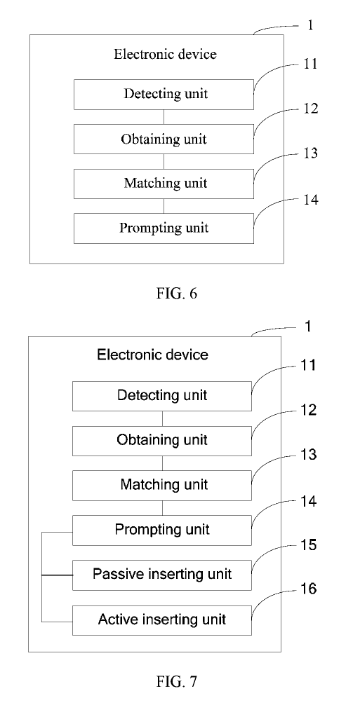

Another embodiment of the present invention provides an electronic device 1, and as shown in FIG. 6, the electronic device includes:
a detecting unit 11, configured to obtain a position of a cursor;
an obtaining unit 12, configured to obtain a first character before the position of the cursor and adjacent to the cursor and a second character after the position of the cursor and adjacent to the cursor, where the first character is a single character or a character string including multiple characters, and the second character is a single character or a character string including multiple characters;
a matching unit 13, configured to obtain, from an input method database, a character grammatically associated with at least one of: the first character and the second character; and
a prompting unit 14, configured to prompt, in the form of a candidate character list, a user for the character grammatically associated with at least one of: the first character and the second character.

The obtaining unit 12 may be specifically configured to:
perform character obtaining backwards from the position of the cursor to a text control character to obtain the first character; and
perform character obtaining forwards from the position of the cursor to a text control character to obtain the second character, where
the text control character includes: a punctuation mark, a carriage return, and a line break.

Alternatively, the obtaining unit 12 may be specifically configured to:
perform character obtaining backwards from the position of the cursor, and if no text control character is obtained but the length of an obtained character reaches a preset character length, stop the obtaining to obtain the first character; and
perform character obtaining forwards from the position of the cursor, and if no text control character is obtained but the length of an obtained character reaches the preset character length, stop the obtaining to obtain the second character, where
the preset character length is a preset upper limit for the length of the obtained character.

Further, as shown in FIG. 7, the electronic device 1 may further include:
a passive inserting unit 15, configured to receive a third character selected by the user in the candidate character list, and display the third character at the position of the cursor, where the third character is a single character or a character string including multiple characters; and
an active inserting unit 16, configured to, when the candidate character list has only one candidate third character, display the third character at the position of the cursor, where the third character is a single character or a character string including multiple characters.

The active inserting unit 16 is further configured to:
when the candidate character list has multiple candidate characters, display a third character that serves as a first option at the position of the cursor, where the third character is a single character or a character string including multiple characters.

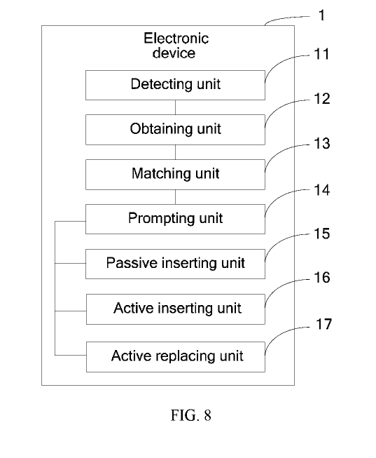

Further, as shown in FIG. 8, the electronic device 1 may further include:
an active replacing unit 17, configured to, when a fourth character formed by characters before and after the position of the cursor has the same attribute as that of the third character, delete the fourth character, so as to delete and replace the fourth character with the third character, where
in a general case, the fourth character has the same length as that of the third character, and the same attribute includes the same pronunciation or the same meaning.

Further, the detecting unit 11 may be specifically configured to:
after the cursor stops moving, detect retention duration of the cursor; and when the retention duration of the cursor reaches preset duration, obtain the position of the cursor; or
receive a cursor position obtaining instruction from the user, and execute the cursor position obtaining instruction to obtain the position of the cursor.

The matching unit 13 may be specifically configured to:
match the first character and the second character with a character in the input method database, and search for a character grammatically associated with the first character and the second character; or
match the first character or the second character with a character in the input method database, and search for a character grammatically associated with the first character or the second character, where
the prompting, in the form of a candidate character list, a user for the character grammatically associated with at least one of: the first character and the second character specifically includes prompting, in the form of a candidate character list, the user for any combination of the following three types of characters: a single character that forms a word or a sentence with the first character and the second character, or a character string that includes multiple characters and forms a word or a sentence with the first character and the second character; a single character that forms a word or a sentence with the first character, or a character string that includes multiple characters and forms a word or a sentence with the first character; and a single character that forms a word or a sentence with the second character, or a character string that includes multiple characters and forms a word or a sentence with the second character.

The prompting unit 14 may be specifically configured to:
sequence characters in the candidate character list one by one according to a matching degree with the first character and/or the second character, and prompt the user for the sequenced characters.

The electronic device provided in the embodiment of the present invention can detect a position of a cursor and obtain characters before and after the cursor, then searches an input method database for a character grammatically associated with the characters before and after the cursor, and prompts, in the form of a list, a user of the character, so that the user can perform selection, and a modification or insertion process is simpler, thereby improving a text editing processing speed of an electronic device.

The electronic device 1 provided in the embodiment of the present invention is applicable to electronic devices having an input function, for example, a personal computer, a tablet computer, and a smart phone, and can execute actions in the foregoing method embodiments.

In addition, various functional units of the electronic device 1 according to each embodiment of the present invention may be integrated into one processing unit or may exist as various separate physical units, or two or more units may also be integrated into one unit. The integrated unit may be implemented in the form of hardware or in the form of a software functional unit.

The integrated unit implemented in the form of a software functional unit may be stored in a computer readable storage medium. The software functional unit is stored in a storage medium, which includes several instructions used for enabling an electronic device (which may be a personal computer, a server, or a network device) to execute part of steps of the methods in the embodiments of the present invention. The storage medium includes various media capable of storing program codes, such as a USB flash disk, a mobile hard disk, a read only memory (Read Only Memory, referred to as ROM), a random access memory (Random Access Memory, referred to as RAM), a magnetic disk, or an optical disk.

The foregoing descriptions are only specific embodiments of the present invention, but are not intended to limit the protection scope of the present invention. Any variation or replacement that can be easily figured out by persons skilled in the art within the technical scope disclosed in the present invention shall all fall within the protection scope of the present invention. Therefore, the protection scope of the present invention shall be subject to that of the claims.

1. A character input prompting method implemented by an electronic device, the method comprising:
obtaining a position of a cursor;
obtaining a first character before the position of the cursor and adjacent to the cursor and a second character after the position of the cursor and adjacent to the cursor, wherein the first character is a single character or a character string comprising multiple characters, and the second character is a single character or a character string comprising multiple characters;
obtaining, from an input method database, a character grammatically associated with at least one of the first character and the second character; and
prompting, in a candidate character list, a user for the character grammatically associated with at least one of the first character and the second character.

2. The character input prompting method according to claim 1, wherein the obtaining the first character before the position of the cursor and adjacent to the cursor and the second character after the position of the cursor and adjacent to the cursor comprises:
performing character obtaining in a backwards direction from the position of the cursor to a first text control character to obtain the first character; and
performing character obtaining in a forwards direction from the position of the cursor to a second text control character to obtain the second character,
wherein the first and second text control characters comprise one of a punctuation mark, a carriage return, or a line break.

3. The character input prompting method according to claim 1, wherein the obtaining the first character before the position of the cursor and adjacent to the cursor and the second character after the position of the cursor and adjacent to the cursor comprises:
performing character obtaining in a backwards direction from the position of the cursor, and if no text control character is obtained but the length of an obtained character reaches a preset character length, stopping the obtaining to obtain the first character; and
performing character obtaining in a forwards direction from the position of the cursor, and if no text control character is obtained but the length of an obtained character reaches the preset character length, stopping the obtaining to obtain the second character,
wherein the preset character length is a preset upper limit for the length of the obtained character.

4. The character input prompting method according to claim 3, further comprising:
receiving a third character selected by the user in the candidate character list, and displaying the third character at the position of the cursor, wherein the third character is a single character or a character string comprising multiple characters.

5. The character input prompting method according to claim 3, further comprising:
when the candidate character list has only one candidate third character, displaying the third character at the position of the cursor, wherein the third character is a single character or a character string comprising multiple characters.

6. The character input prompting method according to claim 3, further comprising:
when the candidate character list has multiple options, displaying a third character that serves as a first option at the position of the cursor, wherein the third character is a single character or a character string comprising multiple characters.

7. The character input prompting method according to claim 6, wherein before the displaying the third character at the position of the cursor, the method further comprises:
when a fourth character formed by characters before and after the position of the cursor has the same attribute as an attribute of the third character, deleting the fourth character, so as to delete and replace the fourth character with the third character,
wherein the fourth character has the same length as a length of the third character, and the same attribute comprises the same pronunciation or the same meaning.

8. The character input prompting method according to claim 7, wherein the obtaining the position of the cursor comprises:
after the cursor stops moving, detecting retention duration of the cursor; and when the retention duration of the cursor reaches a preset duration, obtaining the position of the cursor; or
receiving a cursor position obtaining instruction from the user, and executing the cursor position obtaining instruction to obtain the position of the cursor.

9. The character input prompting method according to claim 7, wherein,
the obtaining, from the input method database, the character grammatically associated with at least one of the first character and the second character comprises:
matching the first character and the second character with a character in the input method database, and searching for a character grammatically associated with the first character and the second character; or
matching the first character or the second character with a character in the input method database, and searching for a character grammatically associated with the first character or the second character,
wherein the prompting, in the candidate character list, a user for the character grammatically associated with at least one of the first character and the second character comprises: prompting, in the candidate character list, the user for any combination of the following three types of characters:
a single character that forms a word or a sentence with the first character and the second character, or a character string that comprises multiple characters and forms a word or a sentence with the first character and the second character;
a single character that forms a word or a sentence with the first character, or a character string that comprises multiple characters and forms a word or a sentence with the first character; and
a single character that forms a word or a sentence with the second character, or a character string that comprises multiple characters and forms a word or a sentence with the second character.

10. The character input prompting method according to claim 9, wherein the prompting, in the candidate character list, the user for the character grammatically associated with at least one of the first character and the second character comprises:
sequencing characters in the candidate character list one by one according to a matching degree with the first character and/or the second character, and prompting the user for the sequenced characters.

11. The character input prompting method according to claim 10, wherein the input method database comprises at least one of: a character library, a word library, and a sentence library.

12. An electronic device, comprising:
a detecting unit, configured to obtain a position of a cursor;
an obtaining unit, configured to obtain a first character before the position of the cursor and adjacent to the cursor and to obtain a second character after the position of the cursor and adjacent to the cursor, wherein the first character is a single character or a character string comprising multiple characters, and the second character is a single character or a character string comprising multiple characters;
a matching unit, configured to obtain, from an input method database, a character grammatically associated with at least one of the first character and the second character; and
a prompting unit, configured to prompt, in a candidate character list, a user for the character grammatically associated with at least one of the first character and the second character.

13. The electronic device according to claim 12, wherein the obtaining unit is configured to:
perform character obtaining in a backwards direction from the position of the cursor to a first text control character to obtain the first character; and
perform character obtaining in a forwards direction from the position of the cursor to a second text control character to obtain the second character,
wherein the first and second text control characters comprise a punctuation mark, a carriage return, or a line break.

14. The electronic device according to claim 12, wherein the obtaining unit is configured to:
perform character obtaining in a backwards direction from the position of the cursor, and if no text control character is obtained but the length of an obtained character reaches a preset character length, stop the obtaining to obtain the first character; and
perform character obtaining in a forwards direction from the position of the cursor, and if no text control character is obtained but the length of an obtained character reaches the preset character length, stop the obtaining to obtain the second character,
wherein the preset character length is a preset upper limit for the length of the obtained character.

15. The electronic device according to any claim 14, further comprising:
a passive inserting unit, configured to receive a third character selected by the user in the candidate character list, and display the third character at the position of the cursor, wherein the third character is a single character or a character string comprising multiple characters.

16. The electronic device according to any claim 15, further comprising:
an active inserting unit, configured to, when the candidate character list has only one candidate third character, display the third character at the position of the cursor.

17. The electronic device according to claim 16, wherein the active inserting unit is further configured to:
when the candidate character list has multiple options, displaying a third character that serves as a first option at the position of the cursor.

18. The electronic device according to claim 17, further comprising:
an active replacing unit, configured to, when a fourth character formed by characters before and after the position of the cursor has the same attribute as an attribute of the third character, delete the fourth character, so as to delete and replace the fourth character with the third character,
wherein the fourth character has the same length as the length of the third character, and the same attribute comprises the same pronunciation or the same meaning.

19. The electronic device according to claim 18, wherein the detecting unit is further configured to:
after the cursor stops moving, detect retention duration of the cursor; and when the retention duration of the cursor reaches a preset duration, obtain the position of the cursor; or
receive a cursor position obtaining instruction from the user, and execute the cursor position obtaining instruction to obtain the position of the cursor.

20. The electronic device according to claim 18, wherein the matching unit is further configured to:
match the first character and the second character with a character in the input method database, and search for a character grammatically associated with the first character and the second character; or
match the first character or the second character with a character in the input method database, and search for a character grammatically associated with the first character or the second character,
wherein the prompting, in the candidate character list, the user for the character grammatically associated with at least one of the first character and the second character comprises prompting, in the form of a candidate character list, the user for any combination of the following three types of characters:
a single character that forms a word or a sentence with the first character and the second character, or a character string that comprises multiple characters and forms a word or a sentence with the first character and the second character;
a single character that forms a word or a sentence with the first character, or a character string that comprises multiple characters and forms a word or a sentence with the first character; and
a single character that forms a word or a sentence with the second character, or a character string that comprises multiple characters and forms a word or a sentence with the second character.

21. The electronic device according to claim 18, wherein the prompting unit is further configured to:
sequence characters in the candidate character list one by one according to a matching degree with the first character and/or the second character, and prompt the user for the sequenced characters.
